(19) United States
(12) Patent Application Publication
(10) Pub. No.: US 2008/0037472 A1
(43) Pub. Date: Feb. 14, 2008

(54) Method of Providing and Receiving Multicast and Broadcasting Service During Handover in Boadband Wireless Access System

(76) Inventors: Gi Seon Ryu, Seoul (KR); Beom Joon Kim, Seoul (KR)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 11/572,892

(22) PCT Filed: Jul. 28, 2005
(86) PCT No.: PCT/KR05/02458

§ 371 Date: Jan. 29, 2007

(30) Foreign Application Priority Data
Jul. 28, 2004 (KR) 10-2004-0059932

(51) Int. Cl. H04Q 7/00

(52) U.S. Cl. 370/332

(57) ABSTRACT

The present invention discloses a method of providing and receiving an MBS during handover in a broadband wireless access system enabling a mobile subscriber station (MSS) in a handover state to seamlessly receive the MBS. The MSS receives MBS-related information with which at least one neighbor BS provides the MBS from a serving BS before handover. The MSS is provided with the MBS seamlessly from a target BS selected from the at least one neighbor BS based on the MBS-related information of the target BS after handover.

### THECHICAL FIELD

The present invention relates to a multicast and broadcasting service (MBS) in a broadband wireless access system. More particularly, the present invention relates to a method of providing and receiving an MBS during handover in a broadband wireless access system enabling a mobile subscriber station (MSS) in a state of handover to receive the MBS seamlessly.

### BACKGROUND ART

Generally, a multicast and broadcasting service (MBS) is a point-to-multipoint service transmitting data from a service source to a plurality of receivers through a common wireless channel for efficient use of wireless resources.

Data transmission between a base station (BS) and a mobile subscriber station (MSS) in a broadband wireless access system is performed by a service flow. The service flow comprises a service flow identifier (SF ID), a connection identifier (CID) identifying connection transferring service flow traffic, and a Quality of Service (QoS) parameter representing quality of the service flow.

Generally, a BS and an MSS make a one-to-one connection of a service flow. The BS, however, transmits identical data to a plurality of MSSs through a service flow since the MBS is a point-to-multipoint service transmitting data from a source to a plurality of receivers. Namely, the BS gives an identical CID to the plurality of MSSs requesting the reception of the MBS when generating service flows for the MBS between the BS and the plurality of MSSs such that the plurality of MSSs can receive identical data for the MBS at the same time.

As described above, a base station transmits data for an MBS after granting an identical CID to all MSSs respecting to receive the data in a broadband wireless access system. By the way, when an MSS receiving the MBS performs handover between a serving BS and a target BS which belong to different MBS zones, the MBS may be provided with different CIDs in the serving BS and the target BS.

Accordingly, the MSS must check whether the target BS provide the MBS if the MSS wish to receive the MBS continuously after performing handover. Moreover, when the target BS provides the MBS, the MSS must update establishment information on which CID is used in the target BS for providing the MBS. Unless the above-described procedures are performed, the MSS receiving real-time data for the MBS can miss packets during hadover.

There is no method or procedure for acquiring information necessary for receiving an MBS continuously after handover in prior art, which makes an MSS receiving the MBS have difficulty in receiving the MBS seamlessly from a target BS after performing handover.

### DISCLOSURE OF INVENTION

Accordingly, the present invention is directed to a method of providing and receiving a multicast and broadcasting service (MBS) during handover in broadband wireless access system that substantially obviates one or more problems of the related arb.

An object of the present invention is to provide a method of providing and receiving an MBS during handover enabling an MSS receiving the MBS from a serving BS to receive the MBS from a target BS after handover.

Another object of the present invention is to define a method and a procedure for acquiring information on whether neighbor BSs provides an MBS which is received from a serving BS and information necessary for receiving the MBS from a target BS after handover.

To achieve these objects and other advantages and in accordance with one aspect of the invention, the present invention provides a method of providing a multicast and broadcasting service (MBS) to a mobile subscriber station (MSS) during handover in a broadband wireless access system, the method comprising: acquiring at a serving base station MBS-related information with which at least one neighbor base station provides the MBS; transmitting the MBS-related information to the MSS; and providing at a base station determined as a target base station among the at least one base station the MBS to the MSS according to the MBS-related information of the target base station.

In accordance with another aspect of the present invention, the present invention provides method of receiving a multicast and broadcasting service (MBS) in a mobile subscriber station (MSS) in a broadband wireless access system, the method comprising: receiving from a serving base station MBS-related information with which at least one neighbor base station provides the MBS; determining a target base station among the at least one neighbor base station; and receiving the MBS from the target base station in accordance with the MBS-related information of the target base station.

### BRIEF DESCRIPTION OF DRAWINGS

The accompanying drawings, which are included to provide a further understanding of the invention and are incorporated in and constitute a part of this application, illustrate embodiments of the invention and together with the description serve to explain the principles of the invention.

FIG. 1 illustrates an example of a reference model for an MBS in broadband wireless access system.

FIG. 2 illustrates an example configuring MBS zone IDs.

FIG. 3 illustrates a flowchart according to a preferred embodiment of the present invention.

### BEST MODE FOR CARRYING OUT THE INVENTION

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings. Embodiments described below are examples with which technical features of the present invention are applied in a broadband wireless access system. It should be appreciated by those having ordinary skill in the art that the technical features of the present invention can be applicable to other wireless communications systems as well as the broadband wireless access system.

Reference will now be made in detail to the preferred embodiments of the present invention, examples of which are illustrated in the accompanying drawings. Wherever possible, the same reference numbers will be used throughout the drawings to refer to the same or like parts.

As described above, the present invention relates to a method of providing and receiving an MBS during handover enabling an MSS receiving the MBS from a serving BS to receive the MBS seamlessly from a target BS after handover. The MSS receives before handover MBS-related information with which at least one neighbor BS provides the MBS from a serving BS. The MSS is provided with the MBS seamlessly from a target BS selected from the at least one neighbor BS based on the MBS-related information of the target BS after handover.

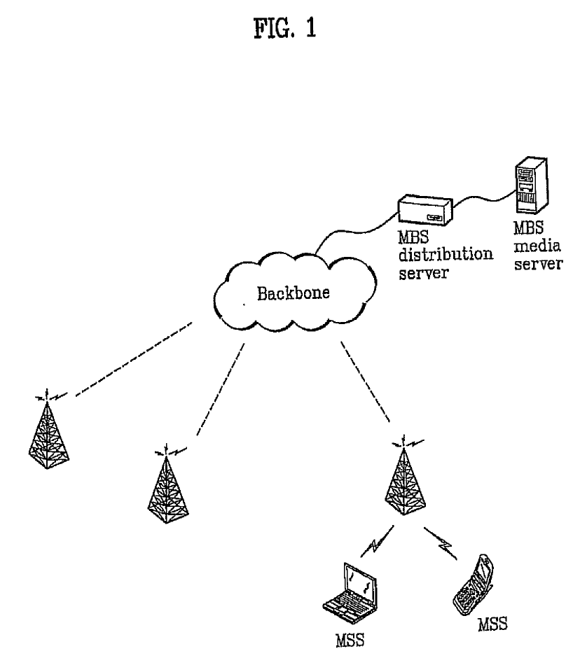

FIG. 1 illustrates an example of a reference model for an MBS in broadband wireless access system. In FIG. 1, a system for providing an MBS comprises an MBS media server, an MBS distribution server, a plurality of BSs, and a plurality of MSSs. The MBS media server provides the plurality of BSs with MBS data and performs authentication of MSSs and distribution of encryption key for the MBS. Alternatively, the MBS distribution server can be omitted and the MBS media server performs scheduling of the MBS data. The plurality of BSs provide the plurality of MSSs with the MBS data transferred from a backbone network through common air interface (CAI). The plurality of MSSs receive the MBS data transmitted from the plurality of BSs.

Parameters (such as a security key or a multicast connection ID, etc) can be established differently according to zone and MBS contents can be broadcasted in a limited zone. Accordingly, when an MSS moves to other BS or performs handover, the MSS must check whether MBS-related information is valid and whether the MBS contents can be received seamlessly. If the BS within which the MSS is moved provides the MBS based on MBS-related parameters different from the information stored in the MSS or the BS does not provide the MBS at all, the MSS must access to other BS to update the parameters for the MBS. To avoid such problem, the concept of ‘MBS zone’ grouping one or more BS providing an MBS is adopted in a broadband wireless access system.

BSs in an MBS zone transmit contents for an MBS to a plurality of BSs based on identical parameters and provide an MBS zone ID to the plurality of MSSs for enabling the plurality of MSSs to identify the MBS zone. An MSS can check the validity of the MBS parameters stored in the MSS through the MBS zone ID received from a BS. When the MSS moves from a BS to other BS in a same MBS zone, procedures for re-establishing MBS-related parameters are unnecessary for receiving the MBS. Moreover, reception efficiency of the MBS data in the MSS can be enhanced through the effect of macro diversity since the BSs in the same MBS zone transmit same MBS data using same wireless resources at the same time.

Each BS can indicate whether to provide the MBS using the MBS zone ID. It is necessary for each BS to inform the MSS whether to provide the MBS since there can be BSs providing the MBS and BSs not providing the MBS in accordance with MBS zones. Accordingly, the MSS is provided with the MBS zone ID when generating a service flow for the MBS and receives the MBS using identical establishment information when moving another BS belonging to the same MBS zone.

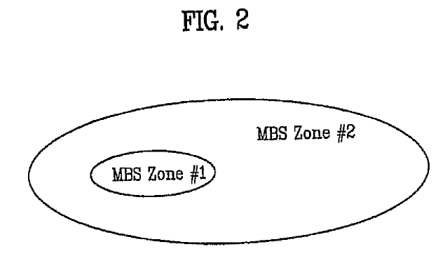

FIG. 2 illustrates an example configuring MBS zone IDs. In FIG. 2, an MBS zone comprises at lease one BS providing an MBS. BSs having an identical MBS zone ID transmit contents for the MBS with an identical CID. A BS may have two or more MBS zone IDs, for example, in FIG. 2 BSs in the MBS zone #1 can have an MBS zone ID #1 and an MBS zone ID #2.

Accordingly, an MSS performing handover between two BSs having an identical MBS zone ID can receive an MBS seamlessly before and after the handover without performing any procedure like an update of CID, etc.

A serving BS transmits information on whether to provide an MBS through a medium access control (MAC) management message to an MSS during an initial registration of the MSS with a network. Table 1 is an example of message type of the MAC management message having information on whether a BS provides the MBS through bitmap in a type of type length value (TLV). The BS can transmit the information on whether to provide the MBS through bitmap in a mobility support TLV.

TABLE 1

| | Length | | |
|---|---|---|---|
| Type | (byte) | Value | Scope |
| 5.24.1 | 1 | Bit #0: Handover support | REG-REQ |
| | | Bit #1: Sleep-mode | REG-RSP |
| | | support | |
| | | Bit #2: Idle-mode support | |
| | | Bit #3: MBS support | |

The base station transmits MBS-related information of at least one neighbor BS to at least one MSS. The MBS-related information includes information on whether each of the at least one neighbor BS provides the MBS and MBS zone ID(s) of the at least one neighbor BS, Preferably, the MBS-related information is transmitted to the at least one MSS through the MAC management message broadcasted periodically.

Table 2 an example of data format of the MAC management message through which the serving base station provides the at least one MSS with the MBS-related information of the at least one neighbor BS. Table 3 and Table 4 are examples of data formats for informing the information on whether each of the at least one BS provides the MBS and the MBS zone ID respectively, among the MBS-related information included in the MAC management message.

TABLE 2

| Syntax | Size | | Notes |
|---|---|---|---|
| MOB-NBR-ADV_Message_Format( ) | | | |
| { | | | |
| Management Message Type = 49 | 8 | bits | |
| N_NEIGHBORS | 8 | bits | |
| For (j=0 ; j<N_NEIGHBORS ; | | | |
| j++) { | | | |
| Neighbor BS-ID | 48 | bits | |

| | | |
|---|---|---|
| TLV Encoded Neighbor | Variable | TLV specific |
| information | | |
| } | | |

| | | |
|---|---|---|
| HMAC Tuple | 21 | bytes |
| } | | |

TABLE 3

| Type | Length | Value | Scope |
|---|---|---|---|
| TBD | 1 | Bit #1: MBS support | TBD |

TABLE 4

| Type | Length | Value | Scope |
|---|---|---|---|
| TBD | TBD | MBS Zone ID | TBD |

The serving BS informs the MSS of the MBS-related information including information on whether the at least one of neighbor BS provides the MBS and the MBS zone IDs of neighbor BSs providing the MBS before the MSS performs handover such that the MSS can use the MBS-related information as a parameter for determining the target BS and receive the MBS seamlessly based on the MBS-related information after handover.

As described in FIG. 2, a BS can have a plurality of MBS zone IDs since MBS zones can be established differently for a plurality of MBSs. It is preferable for the serving BS to provide the at least one MSS with all MBS zone IDs through the MAC management message of Table 2 when a neighbor BS has a plurality of MBS zone ID.

Meanwhile, MBS zone can be managed by exchanging MBS-related information through backbone messages between BSs. Table 5 is an example of an MBS backbone message.

TABLE 5

| Field | Size | Notes |
|---|---|---|
| Message Type=? | 8-bit | |
| Sender BS-ID | 48-bit | Base station unique identifier |
| | | (Same number as that |
| | | broadcasted on the DL-MAP |
| | | message) |
| Recipient BS-ID | 48-bit | Base station unique identifier |
| | | (Same number as that |
| | | broadcasted on the DL-MAP |
| | | message) |
| Time Stamp | 32-bit | Number of milliseconds since |
| | | midnight GMT (set to 0xffffffff |
| | | to ignore) |
| Action | 4-bit | 0: Assign recipient BS to |
| | | MBS zones |
| | | 1: Remove recipient BS from |
| | | MBS zones |
| | | 2: Query (which MBS zones |
| | | recipient BS belongs to?) |
| | | 3: Response (MBS zones where |
| | | sender BS belongs) |
| | | 4: No support MBS |
| | | 5-15: reserved |
| Num Records | 4-bit | Number of MBS zone ID records |
| For (j=0; j<Num | | |
| Records; j++{ | | |
| MBS zone ID | 64-bit | MBS zone ID |
| Num CIDs | 8-bit | Number of CIDs on which |
| | | services are transmitted in MBS |
| | | zone |
| For (k=0; k<Num | | |
| CIDs; K++{ | | |
| Field Size | 16-bit | |
| CID | 16-bit | |
| Required QoS | variable | 11.13 QoS Parameter definition |
| | | encodings that in combination |
| | | define an Admitted QoS Param Set |
| | | specified to the CID |
| } | | |
| } | | |
| Security field | TBD | A means to authenticate this |
| | | message |

The serving BS requests the MBS-related information (for example, information on whether to provide the MBS, the MBS zone ID, the CID, QoS information, etc.) to the at least one neighbor BS through the MBS backbone message of Table 5 and acquires the MBS-related information from the at least one neighbor BS. An MBS controller which may be a BS or an entity above the BS can add a BS to an MBS zone or remove a BS from an MBS zone.

More specifically, when adding a new BS to an MBS zone the MBS controller sets up the action code of the MBS management message (‘0’), the MBS zone ID, the CID, and the QoS parameter, etc and transmits the MBS management message to the new BS. On the contrary, when removing a BS from the MBS zone the MBS controller sets up the action code (‘1’) and the MBS zone ID and transmits the MBS management message to the BS.

Further, when the serving BS wishes to acquire the MBS-related information from a neighbor BS the serving BS sets up the action code (‘2’) and transmits the MBS management message to the neighbor BS. When providing the MBS the neighbor BS sets up the action code (‘3’), the MBS zone ID, the CID, and the QoS parameter etc. and transmits the MBS management message to the serving BS. Unless the neighbor BS provides the MBS the neighbor BS sets up the action code with ‘4’ and transmits the MBS management message to the serving BS.

The messages and parameters described above are just examples for the preferred embodiments of the present invention. It is apparent to those having ordinary skill in the art that different types of messages and parameters can be used to fulfill the object of the present invention.

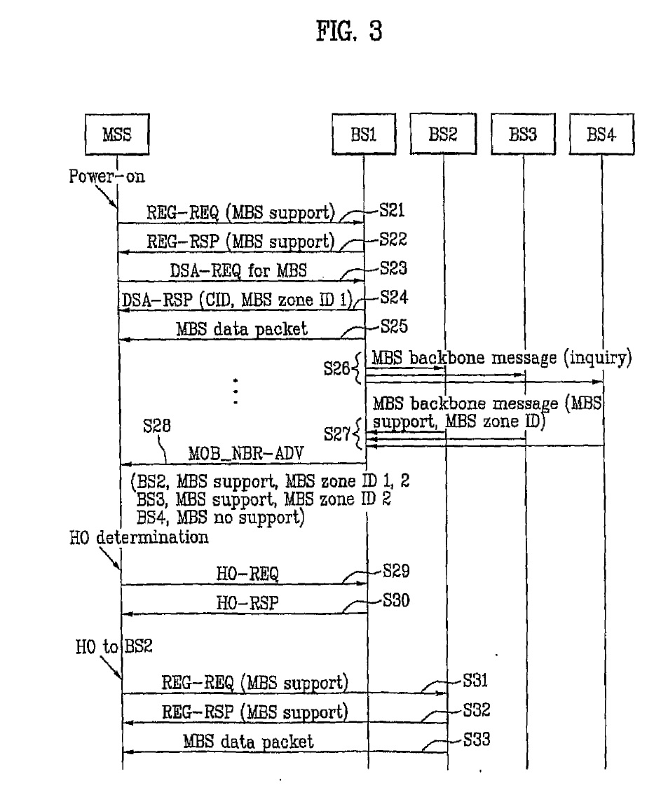

FIG. 3 is a flowchart illustrating a preferred embodiment of the present invention. FIG. 3 illustrates a procedure in an MSS receiving an MBS after registration with a network and performing handover with receiving the MBS.

In FIG. 3, the MSS transmits a registration request (REG-REQ) message during registration with the network to a serving BS (BS1) for inquiring whether the serving BS provides the MBS [S21]. The serving BS informs the MSS of whether to provide the MBS through a registration response (REG-RSP) message [S22].

The MSS requests reception of the MBS to the serving BS through a DSA-REQ message [S23] and the serving BS responds to the request by informing the MSS of a CID and an MBS zone ID for providing the MBS through a DSA-RSP message [S24]. The MSS receives MBS data from the serving BS using the CID and the MBS zone ID [S25].

The serving BS requests neighbor BSs (BS2˜BS4) to provide MBS-related information [S26] and receives the MBS-related information from the neighbor BSs through an MBS backbone message [S27]. The serving BS transmits the MBS-related information of the neighbor BSs to the MSSs through a MAC management (MOB_NBR-ADV) message broadcasted periodically by the serving BS [S28]. Namely, the serving BS broadcasts the MBS-related information including information on whether each of the neighbor BSs provides the MBS and the MBS zone IDs of the neighbor BSs.

During receiving the MBS from the serving BS, the MSS checks whether handover to a neighbor BS is necessary. The MSS determines a target BS among the neighbor BSs (BS2˜BS4) based on quality of reception signal and the MBS-related information received from the serving BS. Namely, the MBS-related information of each neighbor BS as well as the quality of reception signal from each neighbor BS is preferably considered in determining the target BS. For example, a neighbor BS which does not provide the MBS can be excluded when determining the target BS although the quality of the reception signal from the neighbor BS is much better than that of the serving BS. In FIG. 3, BS2 is determined as the target BS. For performing handover, the MSS transmits a handover request (HO-REQ) message [S29]. After receiving a handover response (HO-RSP) message [S30], the MSS transmits a registration request (REG-REQ) message to the target BS for inquiring whether the target BS provides the MBS [S31]. The target BS responds to the to registration request message by transmitting a registration response (REG-REQ) message to the MSS [S32]. The MSS can receive the MBS data from the target BS (BS2) seamlessly [S33].

As described above, the present invention enables the MSS to check whether the serving BS provides the MBS and to receive the MBS seamlessly after handover by transmitting the MBS-related information of neighbor BSs to the MSS periodically.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The present invention is applicable to a wireless communication system such as a mobile communication system or a portable internet system, etc.

1. A method of providing a multicast and broadcasting service (MBS) to a mobile subscriber station (MSS) during handover in a broadband wireless access system, the method comprising:
acquiring at a serving base station MBS-related information with which at least one neighbor base station provides the MBS;
transmitting the MBS-related information to the MSS; and
providing at a base station determined as a target base station among the at least one base station the MBS to the MSS according to the MBS-related information of the target base station.

2. The method of claim 1, wherein the serving base station acquires the MBS-related information from the at least one neighbor base station through at least one MBS management message.

3. The method of claim 1, wherein the MBS-related information includes information on whether each neighbor base station provides the MBS and MBS zone identifier(s) of the at least one neighbor base station.

4. The method of claim 3, wherein the MBS-related information further includes connection identifier(s) and Quality of Service(s) of the at least one neighbor base station.

5. The method of claim 1, wherein the MBS-related information is transmitted to the MSS through a medium access control (MAC) management message.

6. The method of claim 5, wherein the MAC management message is broadcasted periodically by the serving base station.

7. The method of claim 1, wherein the MBS-related information is information associated with all MBSs provided by the at least one neighbor base station.

8. The method of claim 1, wherein the target base station is determined based on the MBS-related information of the at least one neighbor base station.

9. A method of receiving a multicast and broadcasting service (MBS) in a mobile subscriber station (MSS) in a broadband wireless access system, the method comprising:
receiving from a serving base station MBS-related information with which at least one neighbor base station provides the MBS;
determining a target base station among the at least one neighbor base station; and
receiving the MBS from the target base station in accordance with the MBS-related information of the target base station.

10. The method of claim 9, wherein the MBS-related information includes information on whether each neighbor base station provides the MBS and MBS zone identifier(s) of the at least one neighbor base station.

11. The method of claim 10, wherein the MBS-related information further includes connection identifier(s) and Quality of Service(s) of the at least one neighbor base station.

12. The method of claim 9, wherein the MBS-related information is received through a medium access control (MAC) management message.

13. The method of claim 12, wherein the MAC management message is broadcasted periodically by the serving base station.

14. The method of claim 9, wherein the MBS-related information is information associated with all MBSs provided by the at least one neighbor base station.

15. The method of claim 9, wherein the target base station is determined based on the MBS-related information of the at least one neighbor base station.

16. The method of claim 15, wherein a neighbor base station not providing the MBS is excluded when determining the target base station.
